(19) United States
(12) Patent Application Publication
(10) Pub. No.: US 2005/0208940 A1
(43) Pub. Date: Sep. 22, 2005

(54) Network service system using a temporary use identifier

(76) Inventors: Masaaki Takase, Kawasaki (JP); Yoichiro Igarashi, Kawasaki (JP); Haruyuki Takeyoshi, Kawasaki (JP)

Correspondence Address: KATTEN MUCHIN ROSENMAN LLP, 575 MADISON AVENUE, NEW YORK, NY, 10022-2585, US

(21) Appl. No.: 10/980,925

(22) Filed: Nov. 4, 2004

(30) Foreign Application Priority Data
Mar. 19, 2004 (JP) 2004-081326

(51) Int. Cl. H04Q 7/20

(52) U.S. Cl. 455/435.1

(57) ABSTRACT

A network service system comprises a temporary user identifier update request transmitting side device which provides a first service to a user and can transmit a request to update a temporary user identifier shared within a system, a temporary user identifier update request receiving side device, which is connected to the transmitting side device by a network, and can receive the update request from the transmitting side device, and provides a second service cooperating with the first service by using the updated temporary user identifier, and a user proxy device, which is connected to the transmitting side and the receiving side devices by the network, and with which the user receives the two services.

### BACKGROUND OF THE INVENTION

1. Field of the Invention

The present invention relates to a service system using a network, and more particularly, to a method for managing a user identifier in a network service system where a plurality of services are cooperatively provided to a user.

2. Description of the Related Art

The present invention targets a field where a plurality of services are cooperatively provided to a user, and a field where a service is configured in a way such that different dealers/providers providing diverse services independently divide a service or cooperate with one another. Specific examples include a service called a ubiquitous service, etc. As such a service, there is network service business which provides a service by embedding a function existing on every daily life scene, for example, a terminal, etc. into a portion of a service via a network function. This business is fundamentally different from business with which a service is received by carrying an existing mobile function such as a notebook computer.

An existing network service typified by a cellular phone has features (restrictions) firstly that a service originating device and an accepting device are the same, secondly that a user must carry an appliance such as a cellular phone, a notebook computer, etc., which is prepared by the user, for example, by being purchased, in order to receive a service.

In the meantime, an idea called ubiquitous computing has been proposed since the latter half of the '80s, and has got attention in recent years. Since the feature of ubiquitous computing is diversely interpreted at present, and has no unique definition. As one interpretation, a system assisting in diverse daily target actions by using a function (computer, etc.) existing on the scene is considered.

In the meantime, in a current mobile service, functions of portable terminals have been improving in an accelerated manner. However, their operations become complex and the prices of the terminals increase due to the improvements in the functions in addition to the physical limitations of the terminals (such as the size and the weight of a main body and a display device). Therefore, functions which are not (cannot) used by most of general users are comprised in many cases. In the meantime, it is one feature that the ubiquitous service tentatively uses a function (device) existing on the scene, and a user does not always need to possess a function (such as a notebook computer) for achieving an object.

In addition, for an existing network system, a function (acceptance) point of a service is a user terminal itself if it is viewed from the user terminal, and a sufficient technique for temporarily using an appliance whose use right or possession right is not owned beforehand, namely, a technique for hiding the privacy of both of dealers/providers and for connecting appliances concerned and managed by the different dealers/providers is demanded.

To achieve the above described object, a method for permitting a possessor (contractor) of a portable terminal to use a device (a display device, etc., available to the pubic) whose property right is not directly owned by the possessor and which is managed by a third person, etc. is required. At this time, while a service is configured via a plurality of dealers/providers, personal information about the contractor of the terminal starting the service is held and managed by a dealer/provider (such as a network connecting provider) that directly makes a contract with the user of the terminal, and it is difficult to pass the personal information to an external dealer/provider without the permission of the contactor (mainly due to covenants of the contract). Besides, for a dealer/provider which manages a device of the terminal responsible for the above described action, receiving only an instruction of operation contents is sufficient, and the personal information of the terminal user who makes start the service is considered not to be required in all cases.

In the above described network service system, how to restrict the personal information to be shared and propagated among dealers/providers in the personal information of a user who makes start a service must be controlled regardless of to what degree a dealer/provider terminating the service requires the personal information of the user. In recent years, also a mechanism with which dealers/providers having diverse roles divide a function to configure a service has been proposed. With such a mechanism, however, there is a problem that privacy control among dealers/providers, namely, a technique for hiding information, which is intended to make an individual unidentifiable, does not exist.

Generally, a basic method for identifying an individual on a network or a computer is to assign an identifier to each individual. However, if a common identifier is used among dealers/providers, personal information of a contractor can possibly propagate up to a dealer/provider to which the contractor does not want to disclose his or her personal information. Accordingly, a technique with which each dealer/provider defines and manages a specific identifier system for a user targeted by each dealer/provider, the identifier of a user who starts a service is hidden between individual dealers/providers tied up, and the user who starts the service cannot be traced from execution information of the service is required.

As conventional techniques for securing the safety of a communication or for managing personal information in a communications system or a service system, the following documents exist.
[Patent Document 1] Japanese Patent Publication No. HEI6-85811 “Method and System for Enabling a Communication via a Switch Network, Method Providing a Safety Function to a Safety Node and a Switch Network, Method for Processing an Encrypted Communication, and Method for Providing a Safety Communication”
[Patent Document 2] Japanese Patent Publication No. 2003-345724 “Information Management Method, Information Management System, Server, and Terminal, and Information Management Program”.

Patent Document 1 discloses a method for providing a safety communication by arranging a safety node, which converts information encrypted in one format into information encrypted in another format or non-encrypted information, and performs reverse conversion, in an electric communications network.

Patent Document 2 discloses an information managing method for making an inquiry to a person who receives a service, for classifying persons who receive services into groups, for protecting the privacy of the persons who receive the services as much as possible, and for properly coping with a change in the circumstances of the persons who receive the services.

With such conventional techniques, however, it is impossible to hide personal information, especially, a user identifier, and to make a user unidentifiable from execution information of a service, when a plurality of services cooperatively operate.

### SUMMARY OF THE INVENTION

An object of the present invention is to make a user on a partner side unidentifiable among a plurality of services by setting a temporary identifier for a cooperative operation to provide a service when the user respectively has user identifiers for a plurality of services, and the plurality of services cooperatively operate, and to further improve the safety of user information by periodically updating the temporary user identifier for the cooperative operation, in view of the above described problems.

A network service system according to the present invention comprises: a temporary user identifier update request transmitting side device which provides a first service to a user and can transmit a request to update a temporary user identifier shared within a system; a temporary user identifier update request receiving side device, which is connected to the transmitting side device by a network, and which can receive the update request from the transmitting side device, and provides a second service cooperating with the first service by using the updated temporary user identifier; and a user proxy device, which is connected to the transmitting side and the receiving side devices by the network, and with which the user receives the two services.

### BRIEF DESCRIPTION OF THE DRAWINGS

FIG. 1 is a block diagram showing the principle of a configuration of a network service system according to the present invention;

FIG. 2 exemplifies the configuration of the network service system where a temporary user identifier is used;

FIG. 3 exemplifies a configuration of a general network service system according to a preferred embodiment;

FIG. 4 explains the generation of a temporary identifier in association registration;

FIG. 5 explains a cooperative operation of a plurality of service devices;

FIG. 6 is a block diagram exemplifying a configuration of a user proxy device;

FIG. 7 is a block diagram exemplifying a configuration of a temporary identifier update request transmitting side device;

FIG. 8 is a block diagram exemplifying a configuration of a temporary identifier update request receiving side device;

FIG. 9 shows a sequence of an association registration process;

FIG. 10 shows a sequence of the association registration process executed in the user proxy device;

FIG. 11 shows a sequence of the association registration process executed in the temporary identifier update request transmitting side device;

FIG. 12 shows a sequence of the association registration process executed in the temporary identifier update request receiving side device;

FIG. 13 explains the whole of a temporary identifier update sequence;

FIG. 14 shows an update process sequence executed in the temporary identifier update request transmitting side device;

FIG. 15 shows an update process sequence executed in the temporary identifier update request receiving side device;

FIG. 16 explains the whole of a temporary identifier update sequence by a request from the user proxy device;

FIG. 17 shows the temporary identifier update process sequence in the user proxy device;

FIG. 18 explains the whole of an association deletion sequence;

FIG. 19 explains information held by the temporary identifier update request transmitting side device (when a random number value is used for a temporary identifier);

FIG. 20 explains information held by the temporary identifier update request receiving side device (when a random number value is used for a temporary identifier);

FIG. 21 explains information held by the user proxy device (when a random number value is used for a temporary identifier);

FIG. 22 explains information included in an association registration request message (when a random number value is used for a temporary identifier);

FIG. 23 explains information included in an association registration reply message (when a random number value is used for a temporary identifier);

FIG. 24 explains information included in a temporary identifier update request message (when a random number value is used for a temporary identifier);

FIG. 25 explains information included in a temporary identifier update reply message (when a random number value is used for a temporary identifier);

FIG. 26 explains information held by the temporary identifier update request transmitting side device (when an irreversible operation value is used for a temporary identifier, and the temporary identifier is not updated);

FIG. 27 explains information held by the temporary identifier update request receiving side device (when an irreversible operation value is used for a temporary identifier, and the temporary identifier is not updated);

FIG. 28 explains information held by the user proxy device (when an irreversible operation value is used for a temporary identifier, and the temporary identifier is not updated);

FIG. 29 explains information included in an association registration request message (when an irreversible operation value is used for a temporary identifier, and the temporary identifier is not updated);

FIG. 30 explains information included in an association registration reply message (when an irreversible operation value is used for a temporary identifier, and the temporary identifier is not updated);

FIG. 31 explains information held by the temporary identifier update request transmitting side device (when an irreversible operation value is used for a temporary identifier, and the temporary identifier is updated);

FIG. 32 explains information held by the temporary identifier update request receiving side device (when an irreversible operation value is used for a temporary identifier, and the temporary identifier is updated);

FIG. 33 explains information held by the user proxy device (when an irreversible operation value is used for a temporary identifier, and the temporary identifier is updated);

FIG. 34 explains information included in an association deletion request message; and,

FIG. 35 explains information included in an association deletion reply message.

### DESCRIPTION OF THE PREFERRED EMBODIMENTS

A preferred embodiment for implementing the present invention is described in detail below with reference to the drawings.

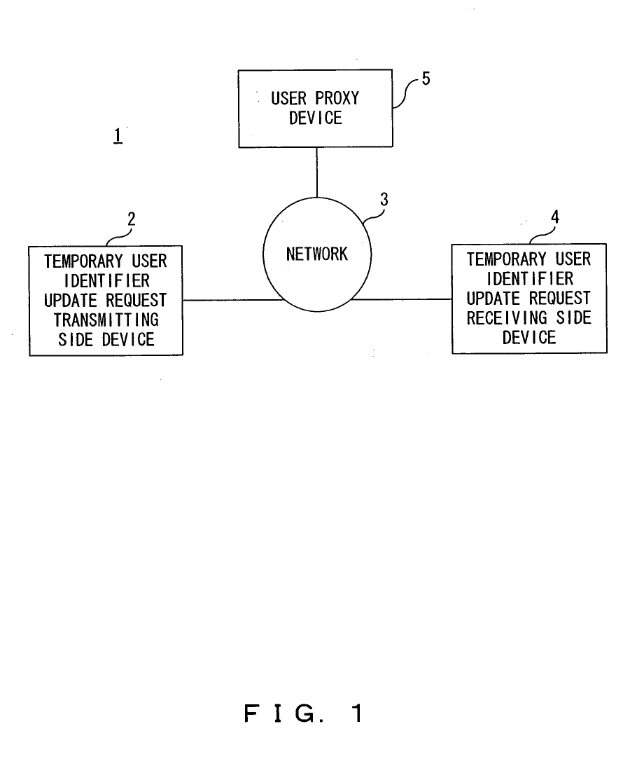

FIG. 1 is a block diagram showing the principle of a configuration of a network service system according to the present invention. This figure is a block diagram showing the principle of the configuration of the network service system where information of a user using a plurality of services is shared by the plurality of services. The system 1 is configured by a temporary user identifier update request transmitting side device 2, a temporary user identifier update request receiving side device 4, and a user proxy device 5, which are interconnected by a network 3.

The temporary user identifier update request transmitting side device 2 is a device for providing a first service to a user. This device can transmit a request to update a temporary user identifier shared within the network service system as user information. The temporary user identifier update request receiving side device 4 is a device which can receive the request to update the temporary user identifier, which is transmitted from the temporary user identifier update request transmitting side device 2. This device provides a second service which cooperates with the above described first service to a user by using the temporary user identifier updated in correspondence with the update request.

The user proxy device 5 is connected to the temporary user identifier update request transmitting side device 2 and the temporary user identifier update request receiving side device 4 by the network. With this device, a user receives the above described first and second services.

In a preferred embodiment according to the present invention, the user proxy device 5 comprises a service information managing unit for holding a user identifier, etc. in a service received by a user, a temporary identifier generating unit for generating a temporary user identifier in correspondence with each user identifier, and a communication processing unit for transmitting a message which includes a pair of the user identifier and the temporary user identifier to the temporary user identifier update request transmitting side device 2 and the temporary user identifier update request receiving side device 4.

The temporary user identifier update request transmitting side device 2 comprises a communication processing unit for receiving the message which is transmitted from the user proxy device 5 and includes the pair of the user identifier corresponding to the first service and the temporary user identifier, a session managing unit for managing the valid time period of the temporary user identifier, and a temporary identifier generating unit for generating a new temporary user identifier before the valid time period of the user (temporary?) identifier expires, wherein the communication processing unit transmits a temporary identifier update request, which includes the new temporary user identifier, to the temporary user identifier update request receiving side device 4.

The temporary user identifier update request receiving side device 4 comprises a communication processing unit for receiving the message which is transmitted from the user proxy device 5 and includes a pair of a user identifier corresponding to the second service and a temporary user identifier, and a session managing unit for managing a new temporary user identifier and its valid time period in correspondence with the temporary identifier update request.

Additionally, the preferred embodiment uses a sequence with which the user proxy device generates a temporary user identifier in correspondence with user identifiers of a user respectively for the temporary user identifier update request transmitting side device 2 and the temporary user identifier update request receiving side device 4, and transmits an association registration request message which includes the generated temporary identifier and its valid time period to these two devices, these two devices transmit an association reply message to the user proxy device 5 after setting the temporary identifier and its valid time period, and the user proxy device 5 sets the valid time period of the above described generated temporary identifier after receiving the association reply message from the two devices.

Furthermore, the above described network service system uses a sequence with which the temporary user identifier update request transmitting side device 2 generates a new temporary identifier before the valid time period of the temporary user identifier shared within the network service system expires, and transmits a temporary identifier update request including the generated temporary identifier and its valid time period to the temporary user identifier update request receiving side device 4, and the receiving side device 4 transmits a temporary user identifier update reply message to the temporary user identifier update request transmitting side device 2 after setting the new temporary user identifier in correspondence with the update request.

In the preferred embodiment, the user proxy device 5 or the temporary user identifier update request transmitting side device 2 can generate a temporary user identifier by using a random number in correspondence with the user identifier, or can generate a temporary user identifier by using an irreversible operation in these two sequences.

Still further, the network service system according to the present invention is configured by a user proxy device, with which a user receives a plurality of services cooperatively executed, for generating a temporary user identifier corresponding to each user identifier in the plurality of services and for transmitting the temporary identifier to the side of the devices providing the respective services, and a plurality of temporary user identifier update request receiving side devices, which are connected to the user proxy device by a network, for providing the respective services cooperatively executed to the user, and for providing the services to the user by using the temporary user identifier transmitted from the user proxy device.

In the preferred embodiment according to the present invention, the user proxy device can comprise a session managing unit for managing the valid time period of a temporary user identifier, a temporary identifier generating unit for generating a new temporary user identifier before the valid time period of the temporary user(?) identifier expires, and a communication processing unit for transmitting a temporary identifier update request to the plurality of temporary user identifier update request receiving side devices by using the new temporary identifier.

According to the present invention, user identifiers in respective services can be hidden among the services when the plurality of services are cooperatively provided to a user, and the personal information of the user can be prevented from propagating. Additionally, the temporary identifier of the user, which is generated for a cooperative operation, is periodically updated, whereby the network service system where the safety of personal information is improved can be implemented.

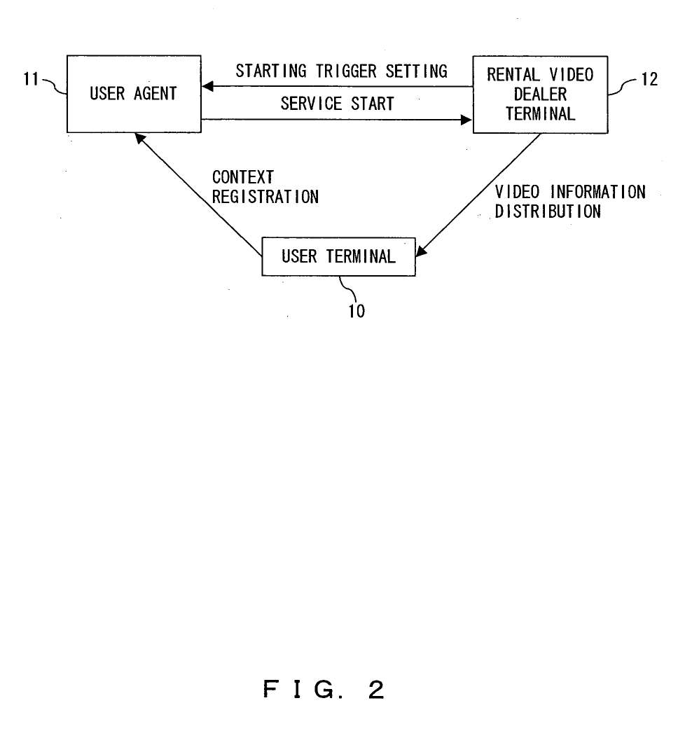

FIG. 2 exemplifies a configuration of a network system where a temporary identifier of a user is used among service systems when the user uses a plurality of services. This figure assumes that the user registers a context, etc. from a user terminal 10 to a user agent 11 such as an Internet service provider (ISP) along with a user identifier for using the user agent 11, and also registers a user identifier for receiving video information, etc. to a rental video dealer terminal 12. Here, the user identifier for the user agent 11, and the user identifier for the rental video dealer terminal 12 may be identical or different. However, it is a premise that the user agent 11 and the rental video dealer terminal 12 do not know the user identifier on the partner side respectively.

The context registered to the user agent 11 is various items of information about the user, such as a person involved in the user at the current time point, an object such as goods, a place, etc., a state of the user (working, etc.), circumstances, a history, a future schedule, etc.

The rental video dealer terminal 12 sets a starting trigger for the user agent 11. This starting trigger is a setting of a starting condition under which the rental video dealer terminal 12 provides a service such as video information distribution, etc. to the user terminal 10. For example, if the user desires that video information is distributed at a time point when arriving at a station close to his or her home after finishing the job, such a condition is set as a starting trigger for the user agent 11.

The user agent 11 instructs the rental video dealer terminal 12 to start the service at the time point when such a starting condition is satisfied, namely, a time when the user arrives at the station close to his or home. The rental video dealer terminal 12 receives from the user agent 11 the information of the context that the user registers to the user agent 11, selects video information in which the user seems to be interested from the use history, etc. of the user at that store, and distributes the selected video information to the user terminal 10.

Here, the user terminal 10 respectively registers the user identifiers to the user agent 11 and the rental video dealer terminal 12. However, the user side can naturally receive video information distributed from the rental vide dealer terminal 12 by registering the user identifier only to the user agent 11, by further registering, for example, a genre of a video in which the user is interested as the contents of the context, and by notifying the user agent 11 side that the user desires the distribution of such vide information from the rental video dealer terminal 12 side, without registering the user identifier to the rental video dealer terminal 12 side.

In any case, in this preferred embodiment, the user identifier/identifiers registered to the user agent 11 and/or the rental video dealer terminal 12 is/are identifiers between the user terminal 10 and the user agent 11 and/or the rental video dealer terminal 12. In a data exchange, etc. between the user agent 11 and the rental video dealer terminal 12, a temporary user identifier is set without using the user identifiers, and the temporary user identifier is used, whereby the user agent 11 and the rental video dealer terminal 12 cooperate to provide a service to the user.

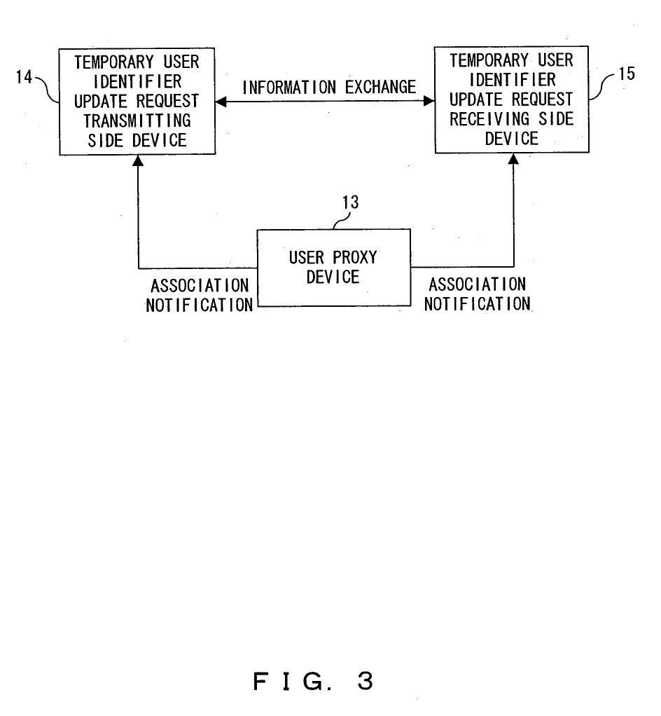

FIG. 3 shows a configuration example of a more general network system, which corresponds to the specific example shown in FIG. 2. In this figure, a user proxy device 13 corresponding to the user terminal 10 shown in FIG. 2 is connected via a network to a temporary user identifier update request transmitting side device 14 and a temporary user identifier update request receiving side device 15, which are also connected via the network.

The temporary user identifier update request transmitting side device 14 corresponds, for example, to the user agent 11 shown in FIG. 2, whereas the temporary user identifier update request receiving side device 15 corresponds to the rental video dealer terminal 12. A data exchange, etc. is made by using a temporary identifier between the user agent 11 and the rental video dealer terminal 12 as described above. As will be described later, a lifetime is set for the temporary identifier, the temporary identifier is updated before the lifetime expires, and the updated temporary identifier is used thereafter.

In FIG. 3, the temporary user identifier update request transmitting side device 14 and the temporary user identifier update request receiving side device 15 are named for the convenience of explanation. Generally, which of these two devices makes an update request depends on a case. In that sense, both of the user agent 11 and the rental video dealer terminal 12, which are shown in FIG. 2, are implemented as a device which can transmit/receive an update request. Here, a preferred embodiment according to the present invention is described by assuming that one of the two devices is the transmitting side device 14, and the other is the receiving side device 15 for the sake of a later explanation. However, in principle, the transmitting side device 14 and the receiving side device 15 are not managed by the same manager, and belong to different management units.

In FIG. 3, the user proxy device 13 makes an association registration to the temporary user identifier update request transmitting side device 14 and the temporary user identifier update request receiving side device 15. With the association registration, a pair of a user identifier and a temporary user identifier is respectively registered, for example, to a service 1 provided by the transmitting side device 14, and a service 2 provided by the receiving side device 15 when the services are started.

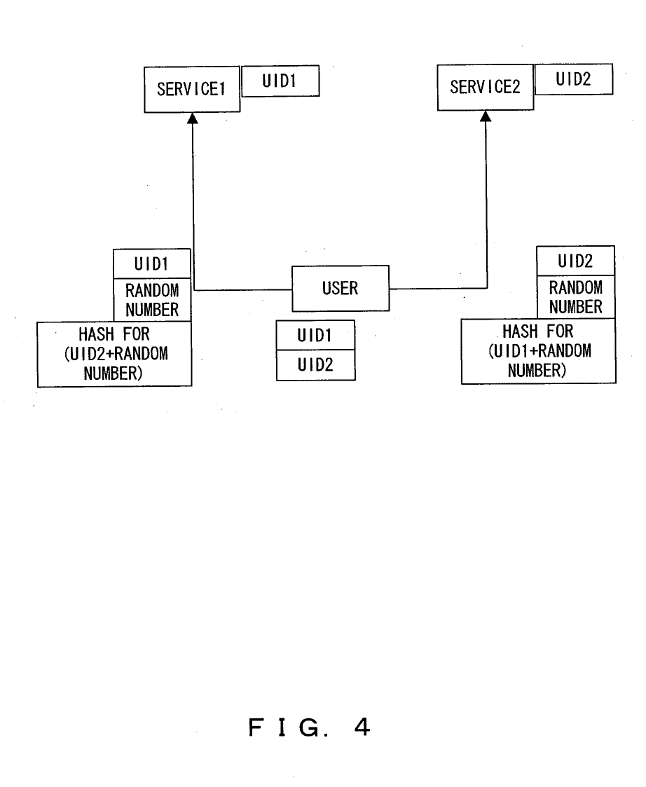

FIG. 4 explains a registration example of a user identifier and a temporary identifier in the association registration. Assume that a user respectively registers UID1 and UID2 as an original user identifier in the service 1 and a user identifier in the service 2. The user generates a temporary identifier corresponding to a service which is provided in a way such that the service 1 and 2 cooperate, and notifies the sides of the services of the temporary identifier.

As the temporary identifier, only a random number may be used as will be described later. Here, the temporary identifier is generated by using a hash operation as an irreversible operation. For example, the user notifies the service 1 of the original user identifier UID1, a random number, and a temporary user identifier pairing with the user identifier and the random number. The random number notified here is used to access the service 2. For the generation of the temporary identifier, the original user identifier UID2 of the user for the service 2 and a random number are used. Namely, the hash operation is performed for a concatenation of UID2 and the random number, and its result is notified to the service 1 side as a temporary identifier. The random number may be identical to or different from the random number notified to the service 1 along with UID1.

To the service 2, a combination of the original user identifier UID2, a random number, and the temporary identifier is notified. As the temporary identifier, a result of the hash operation, which is performed for a concatenation of the original user identifier UID1 corresponding to the service 1 and the random number, is notified.

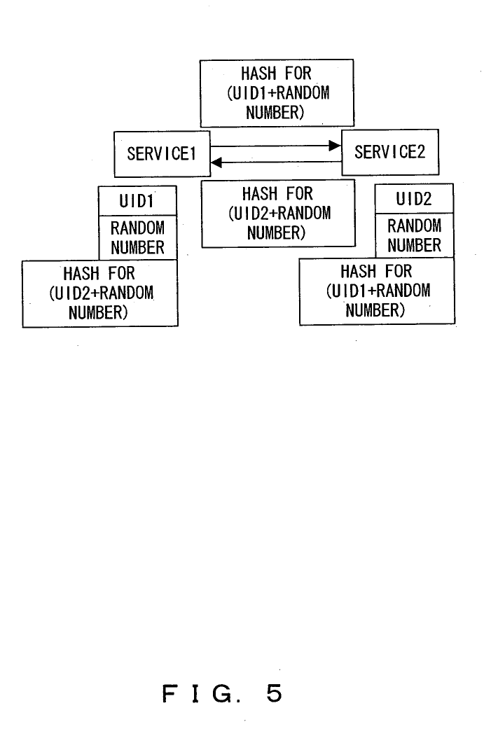

FIG. 5 explains a method using a temporary identifier in a cooperative operation of the services 1 and 2. For example, the service 1 side performs the hash operation for the concatenation of the original user identifier UID1 corresponding to the service 1 and the random number, and uses its result as a temporary identifier in a data exchange, etc. required by the cooperative operation with the service 2. The temporary identifier is notified from the user to the service 2 side, and the service 2 side can identify the user with the temporary identifier. Similarly, from the service 2 side to the service 1 side, a result of the hash operation for the concatenation of UID2 and the random number is used as a temporary identifier. With this temporary identifier, the service 1 side can identify the user.

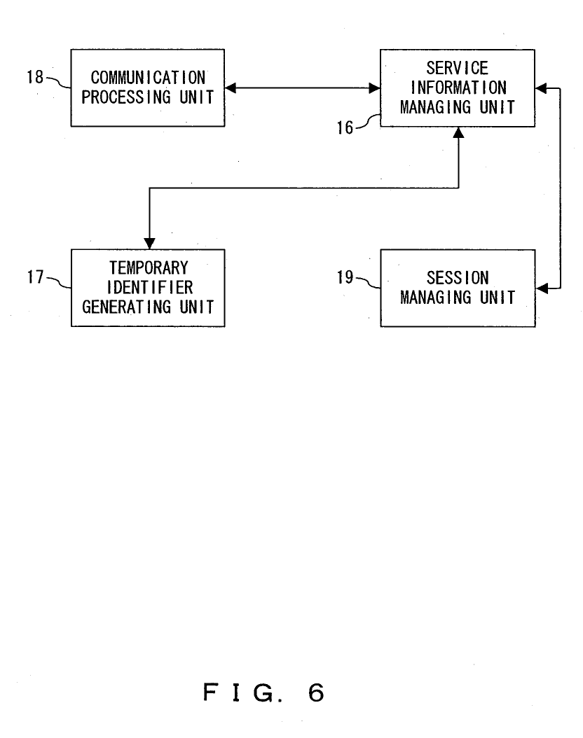

FIG. 6 is a block diagram exemplifying a configuration of the user proxy device 13 shown in FIG. 3. In this figure, the user proxy device 13 comprises a service information managing unit 16 for managing an identifier of a service provided by the update request transmitting side device 14 or the update request receiving side device 15, which is shown in FIG. 3, and an address of the device 14 or 15, a temporary identifier generating unit 17 for generating a temporary identifier used in the association registration, etc. when a service starts, a communication processing unit 18 for communicating with the two devices 14 and 15, and a session managing unit 19 for managing the lifetime of a temporary identifier, for example, when the temporary user identifier is forcibly updated from the user proxy device 13 side. Note that a session means the valid time period of a temporary identifier.

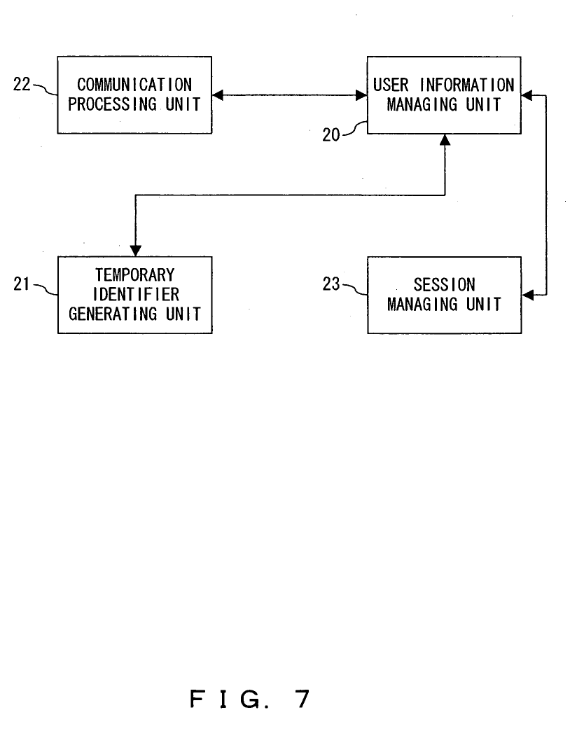

FIG. 7 is a block diagram showing a configuration of the temporary identifier update request transmitting side device 14 shown in FIG. 3. This device comprises a user information managing unit 20 for managing, for example, a pair of a user identifier and a temporary identifier of each user for each service, a temporary identifier generating unit 21 for generating a temporary identifier when the temporary identifier is updated, a communication processing unit 22 for communicating with the update request receiving side device 15 and the user proxy device 13, and a session managing unit 23 for managing the lifetime of the temporary identifier.

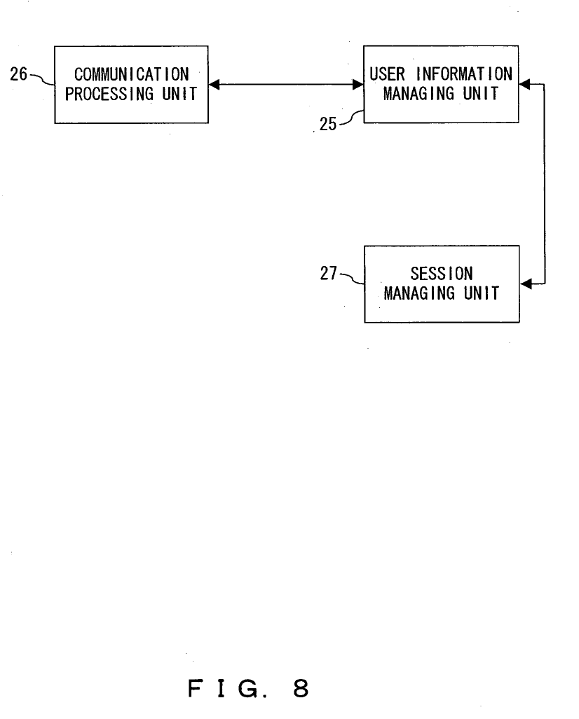

FIG. 8 is a block diagram showing a configuration of the temporary identifier update request receiving side device 15. In this figure, the receiving side device 15 comprises a user information managing unit 25, a communication processing unit 26 for communicating with the user proxy device 13 and the update request transmitting side device 14, and a session managing unit 27 for managing the lifetime of a set temporary identifier in a similar manner as in FIG. 7.

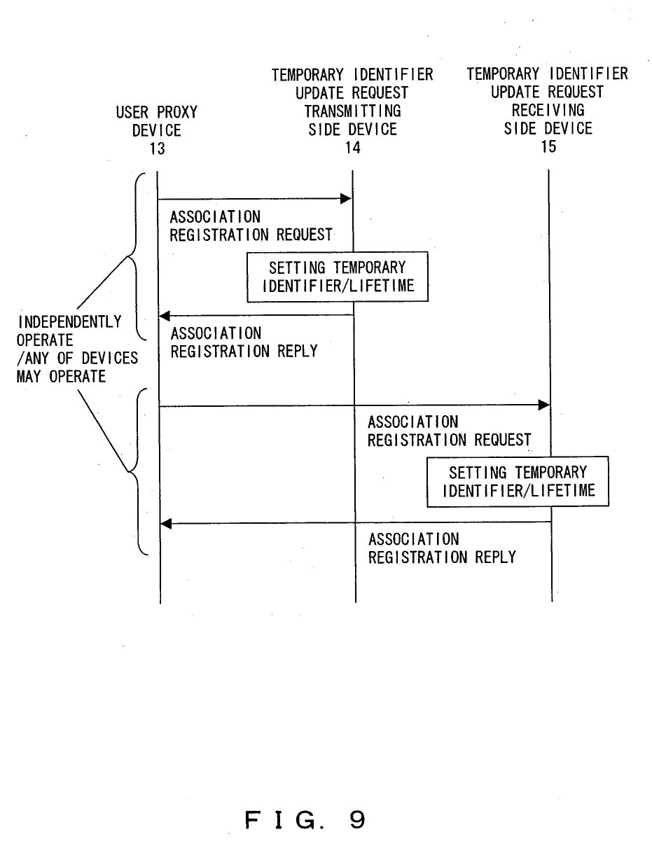

Sequences of processes executed among the respective devices shown in FIG. 3 are explained next with reference to FIGS. 9 to 17. FIG. 9 shows a sequence of an association registration process. In this figure, the use proxy device 3 makes an association registration request to the temporary identifier update request transmitting side device 14 and the temporary identifier update request receiving side device 15. These devices respectively set a temporary identifier and its lifetime in correspondence with the association registration request, and makes an association registration reply to the user proxy device 13. Contents of the registration request and the registration reply messages will be described later.

Here, the processes of the association registration between the user proxy device 13 and the temporary identifier update request transmitting side device 14, and between the user proxy device 13 and the temporary identifier update request receiving side device 15 are mutually independent, and these processes may be basically executed at the same time. If either of the processes is executed in advance, their order doesn't matter.

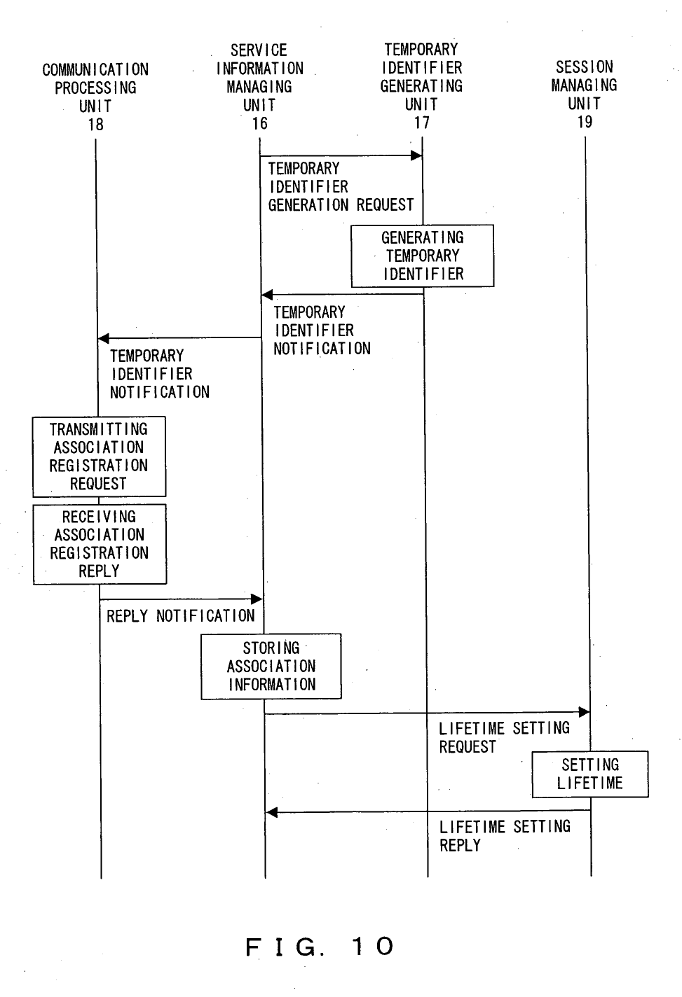

FIG. 10 shows a sequence of the association registration process executed in the user proxy device 13. In this figure, a temporary identifier generation request is made from the service information managing unit 16 to the temporary identifier generating unit 17. A generated temporary identifier is notified from the temporary identifier generating unit 17 to the communication processing unit 18 via the service information managing unit 16. Then, an association registration request is transmitted from the communication processing unit 18 to the update request transmitting side device 14 and the update request receiving side device 15. Association registration replies transmitted from the two devices are received by the communication processing unit 18 in response to the registration request.

In correspondence with these replies, association information, etc. is stored in a memory, etc. by the service information managing unit 16, and a request to set the lifetime of the generated temporary identifier is made to the session managing unit 19. The value of the set lifetime is stored in the memory, etc., and a reply to the request is notified to the service information managing unit 16. The reason why the lifetime is not simultaneously set for the generated temporary identifier before the association registration request is transmitted is that the lifetime is set after a reply which approves the use of the temporary identifier is received from the update request transmitting side device 14 and the update request receiving side device 15 as the association registration reply.

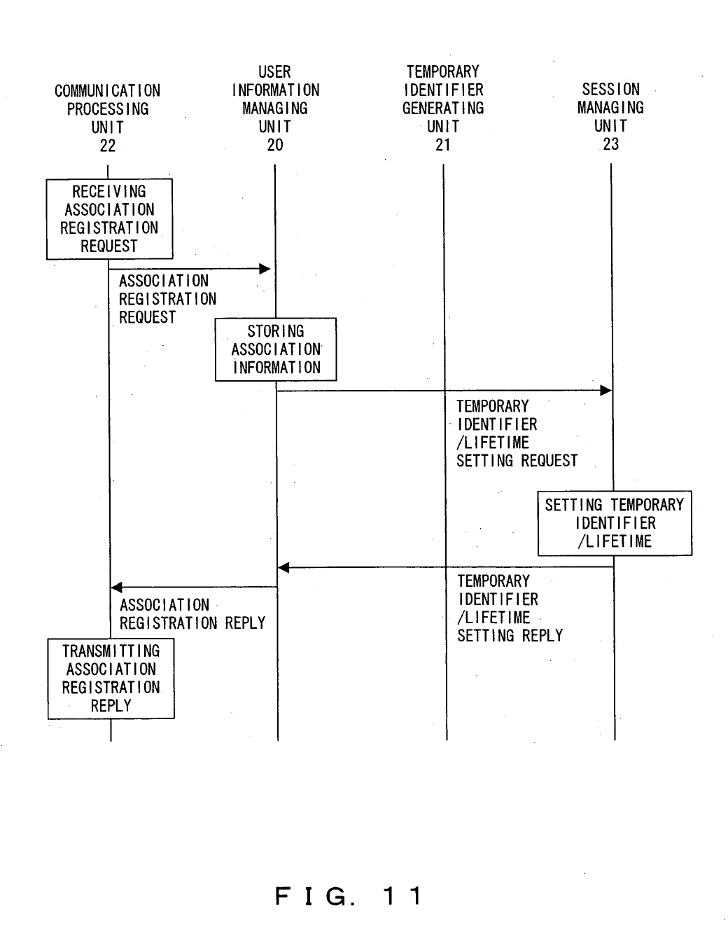

FIG. 11 shows a sequence of the association registration process executed in the temporary identifier update request transmitting side device. In this figure, an association registration request transmitted from the user proxy device 13 is received by the communication processing unit 22, this request is notified to the user information managing unit 20, association information is stored, for example, in a memory, and a lifetime setting request is made from the user information managing unit 20 to the session managing unit 23. Then, a temporary identifier and the value of its lifetime, which are included, for example, in the association registration request message, are stored in the memory, etc., its setting reply is notified to the user information managing unit 20, an instruction of an association registration reply is made from the user information managing unit 20 to the communication processing unit 22, and the association registration reply to the user proxy device 13 side is transmitted.

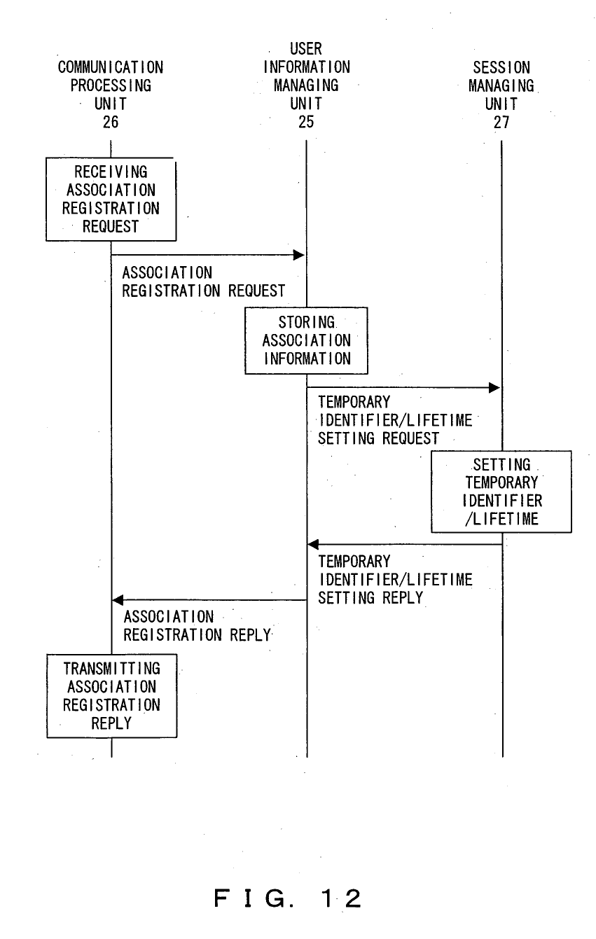

FIG. 12 shows a sequence of the association registration process executed in the temporary identifier update request receiving side device. In this figure, an association registration request transmitted from the user proxy device 13 is received by the communication processing unit 26, this request is notified to the user information managing unit 25, association information is stored, for example, in a memory, etc., and a request to set a temporary identifier and its lifetime is made from the user information managing unit 25 to the session managing unit 27. Then, the temporary identifier and the value of the lifetime, which are included, for example, in the association registration request message, are stored in the memory, etc. by the session managing unit 27, its setting reply is notified to the user information managing unit 25, an instruction of an association registration reply is made from the user information managing unit 25 to the communication processing unit 26, and the association registration reply is transmitted to the user proxy device 13 side.

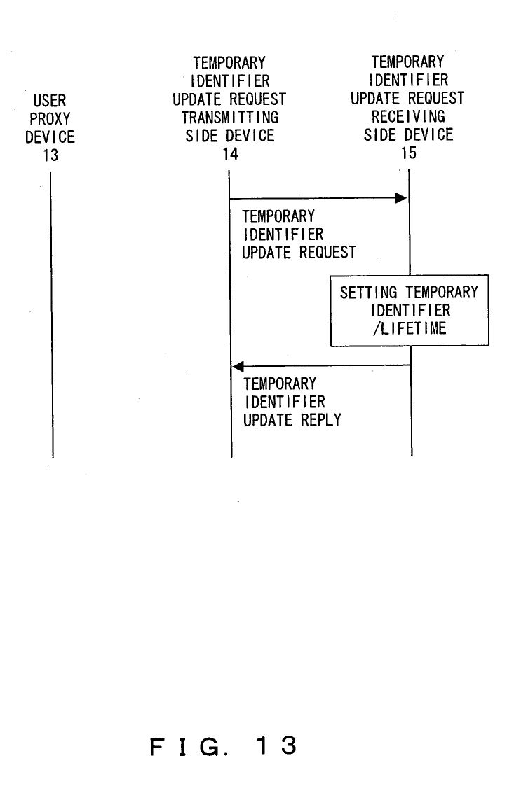

A case where a temporary identifier is updated by a request from the update request transmitting side device 14 in a sequence of a temporary identifier update process is explained with reference to FIGS. 13 to 15. FIG. 13 shows the entire update sequence. In this sequence, a temporary identifier update request is transmitted from the temporary identifier update request transmitting side device 14 to the temporary identifier update request receiving side device 15, a new temporary identifier and its lifetime, which are included in the update request message, are stored in the memory, etc. by the update request receiving side device 15, and a temporary identifier update reply is made from the receiving side device 15 to the update request transmitting side device 14.

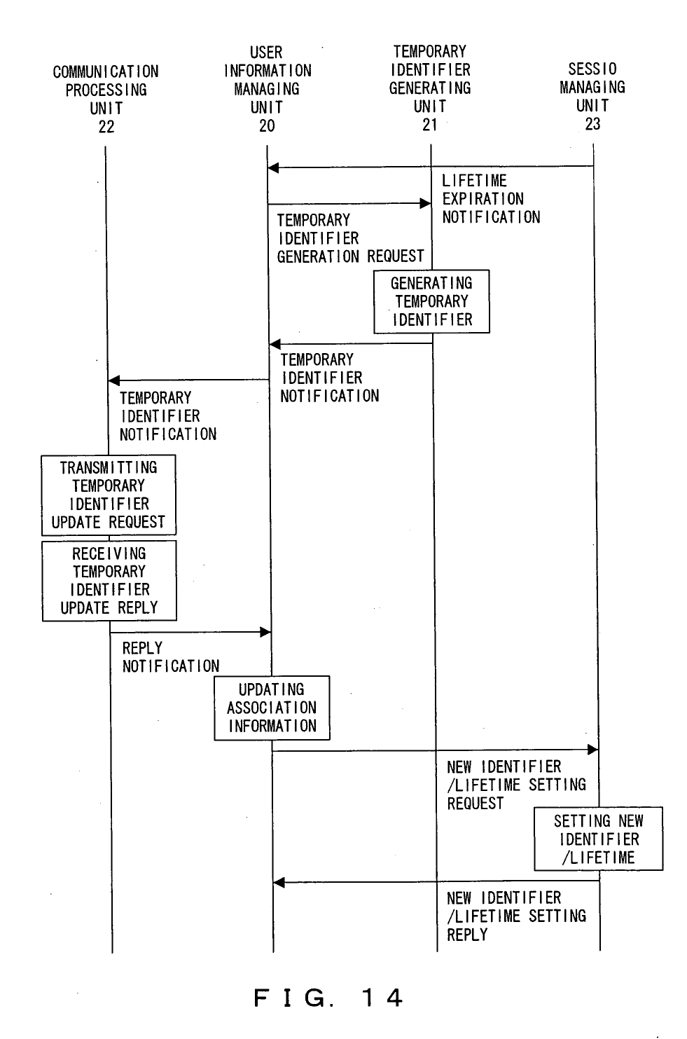

FIG. 14 shows a sequence of the temporary identifier update process executed in the temporary identifier update request transmitting side device 14. In this figure, a lifetime expiration notification is made from the session managing unit 23 to the user information managing unit 20 before the lifetime of the currently set temporary identifier expires. Then, a request to generate a new temporary identifier is made from the user information managing unit 20 to the temporary identifier generating unit 21. The generated temporary identifier is notified to the communication processing unit 22 via the user information managing unit 20. Then, a temporary identifier update request is transmitted from the communication processing unit 22 to the temporary user identifier update request receiving side device 15, and an update reply transmitted from the update request receiving side device 15 in correspondence with the update request is received by the communication processing unit 22, and the update reply is notified to the user information managing unit 20. Then, association information is updated by the user information managing unit 20, and a lifetime setting request is made to the session managing unit 23. After the new temporary identifier and its lifetime are stored in the memory, etc., a lifetime setting reply is notified to the user information managing unit 20.

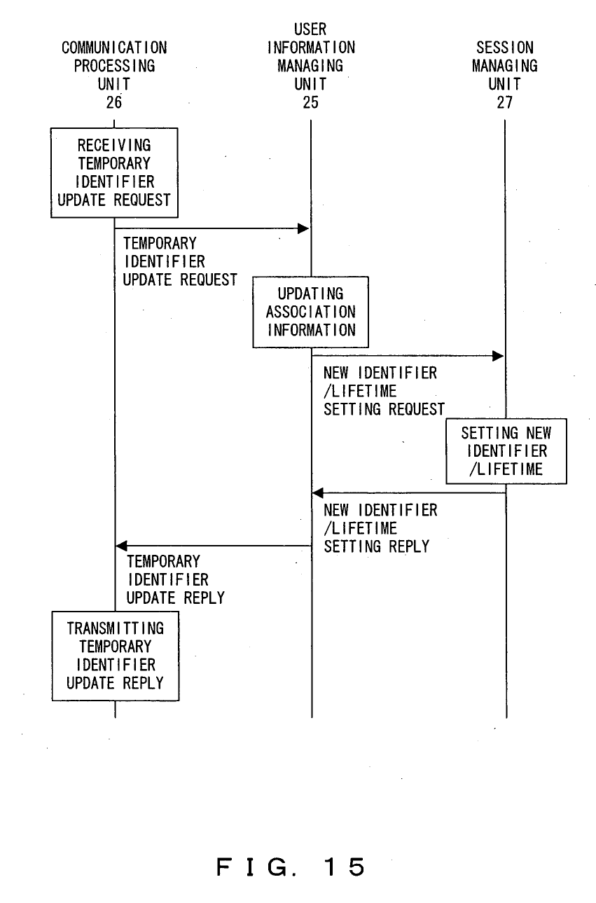

FIG. 15 shows a sequence of the temporary identifier update process executed in the temporary identifier update request receiving side device 15. In this figure, a temporary identifier update request transmitted to the update request receiving side device 15 is received by the communication processing unit 26, and this request is notified to the user information managing unit 25. A request to set the lifetime of a new temporary identifier is transmitted from the user information managing unit 25 to the session managing unit 27 the same time association information is updated. After the new temporary identifier and the value of its lifetime are stored in the memory, etc., a lifetime setting reply is made to the user information managing unit 25, an instruction of a temporary identifier update reply is made from the user information managing unit 25 to the communication processing unit 26, and the temporary identifier update reply is transmitted from the communication processing unit 26 to the update request transmitting side device 14.

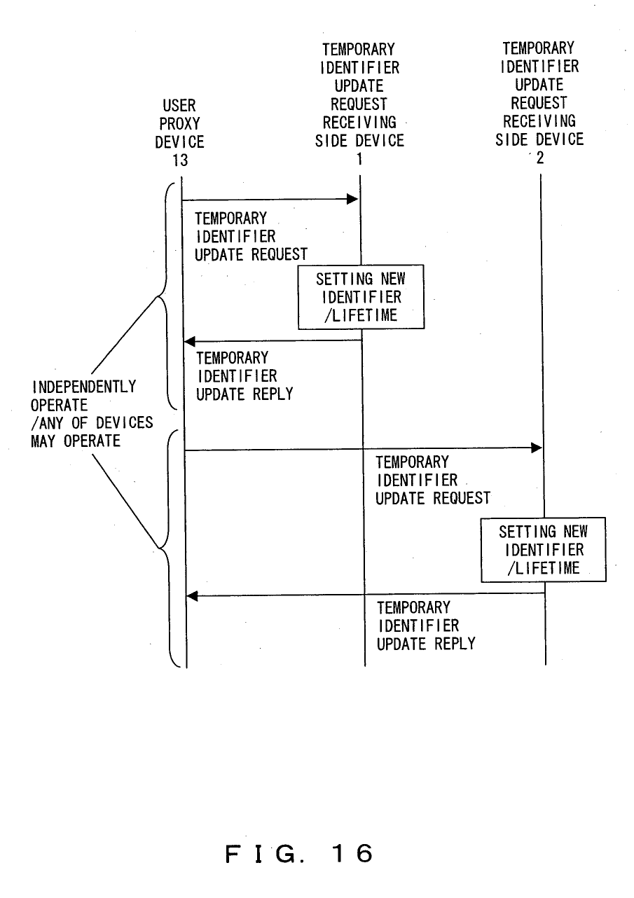

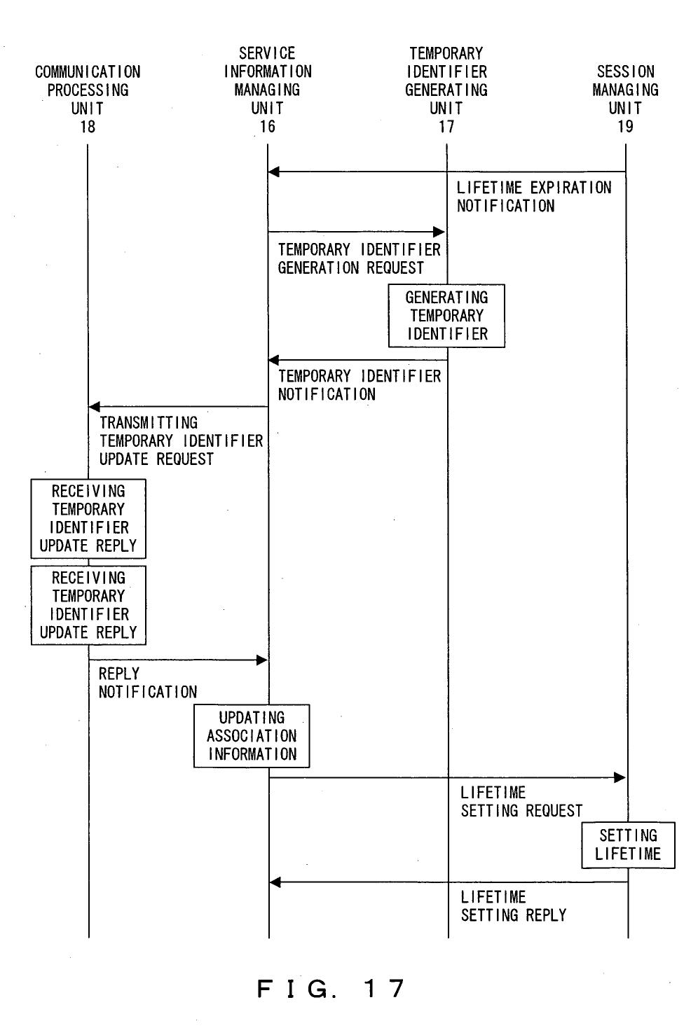

FIGS. 16 and 17 explain a sequence executed when a temporary identifier is updated by a request from the user proxy device 13. In the above provided explanation, an initially used temporary identifier is transmitted from the user proxy device 13 to the update request transmitting side device 14 and the update request receiving side device 15 when a service starts to be used, a data exchange, etc. is made between the transmitting side device 14 and the receiving side device 15 by using a new temporary identifier generated by the update request transmitting side device 14 after the lifetime of the initial temporary identifier expires. However, a temporary identifier update request may be continuously transmitted by the user proxy device 13 to the two devices 14 and 15, and the two devices 14 and 15 may make a data exchange, etc. by using the new temporary identifier included in the update request message. FIGS. 16 and 17 explain the sequence executed in such a case.

Unlike FIG. 3, a temporary identifier update request is transmitted from the user proxy device 13 to two temporary identifier update request receiving side devices in FIG. 16. Then, in a similar manner as in FIG. 9, a new temporary identifier and its lifetime are set on the sides of the two devices, and an update reply is returned to the user proxy device 13.

FIG. 17 shows a sequence of the identifier update process executed in the user proxy device 13. Comparing with the sequence of the association registration process shown in FIG. 10, an expiration notification of the lifetime of the currently set temporary identifier is first transmitted from the session managing unit 19 to the service information managing unit 16 in FIG. 17. Then, a new temporary identifier generation request is made from the service information managing unit 16 to the temporary identifier generating unit 17. The subsequent sequence is fundamentally similar to that shown in FIG. 10.

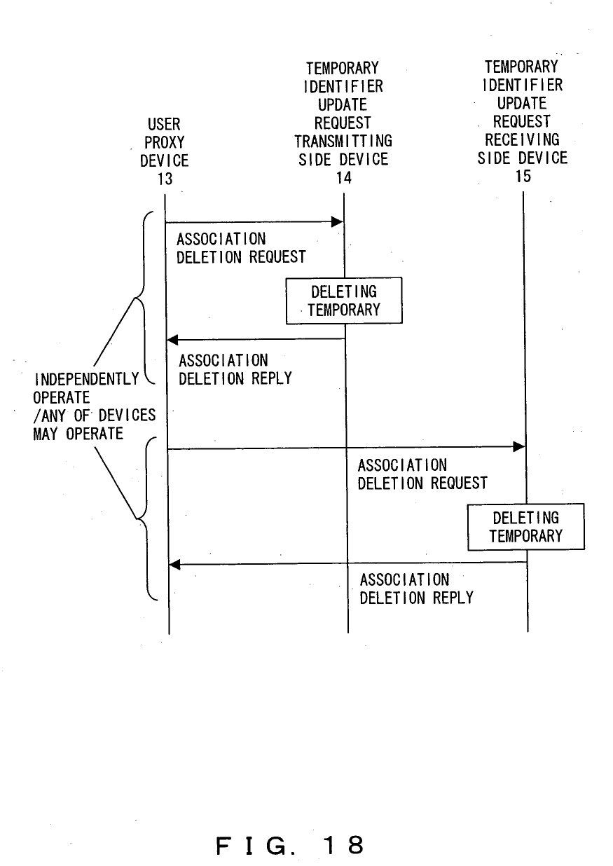

FIG. 18 explains a sequence of an association deletion when a service is terminated. In this figure, the user proxy device 13 transmits an association deletion request to the temporary identifier update request transmitting side device 14 and the temporary identifier update request receiving side device 15, for example, when a service terminates to be received. These two devices delete a temporary identifier corresponding to the user, and a pair of a user identifier and the temporary identifier as association information, and return an association deletion reply to the user proxy device 13. These operations may be simultaneously performed for the two devices. Or, if these operations are sequentially performed, their order may be arbitrary in a similar manner as in the example shown in FIG. 9.

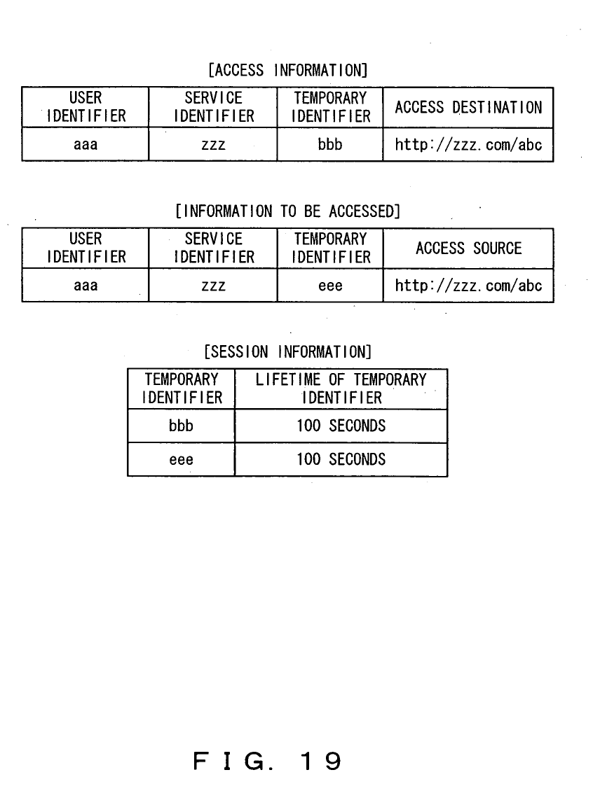

Information held by the user proxy device, the temporary identifier update request transmitting side device, and the temporary identifier update request receiving side device in correspondence with the above described sequences, and information included in the messages between the respective devices, such as the association registration request and reply messages shown in FIG. 9, are explained next. FIG. 19 explains information held by the temporary identifier update request transmitting side device. This figure shows the information held by the temporary identifier update request transmitting side device when a necessary data exchange, etc. is made between the update request transmitting side device and the update request receiving side device after a temporary identifier is generated by using a random number value in correspondence with a user identifier, and the temporary identifier is associated, unlike FIG. 4 where a result obtained by performing the hash operation for the concatenation of the user identifier in a service on a partner side and the random number is defined as a temporary identifier.

In FIG. 19, access information and information to be accessed are first held. These items of information are information required for a data exchange, etc. with the temporary identifier update request receiving side device. The access information is information when the update request transmitting side device accesses the update request receiving side device. As this information, a user identifier of a user, a service on a partner side, namely, an identifier of a service provided by the temporary identifier update request receiving side device, a temporary identifier of the user for using the service, and an address of an access destination are stored.

As the information to be accessed, the user identifier of the user, an identifier of a service on the partner side, the temporary identifier of the user on the update request transmitting device side, and an address of the update request receiving side device as an access source are stored as information for identifying an access from the partner side, namely, the update request receiving side device.

As the information held by the update request transmitting side device, lifetimes of two temporary identifiers are further held as session information. Namely, the lifetimes are respectively held for the temporary identifier bbb for identifying the user in the update request receiving side device on the partner side, and the temporary identifier eee for identifying the user in the update request transmitting side device.

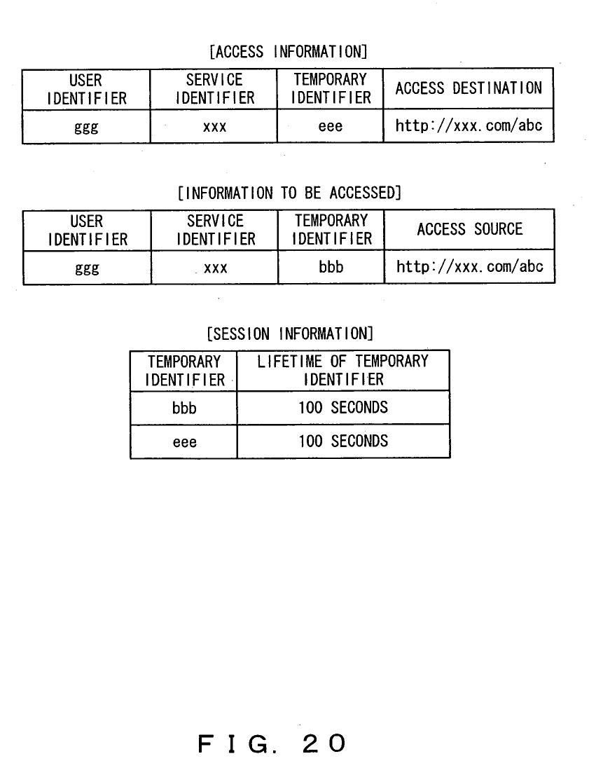

FIG. 20 shows information held by the temporary identifier update request receiving side device, and information in a case where a random number value is used as a temporary identifier in a similar manner as in FIG. 19. Similar to the information held by the temporary identifier update request transmitting side device shown in FIG. 19, access information, namely, information for accessing the update request transmitting side device, information to be accessed, namely, information for identifying an access from the update request transmitting side device, and lifetimes of two temporary identifiers are held.

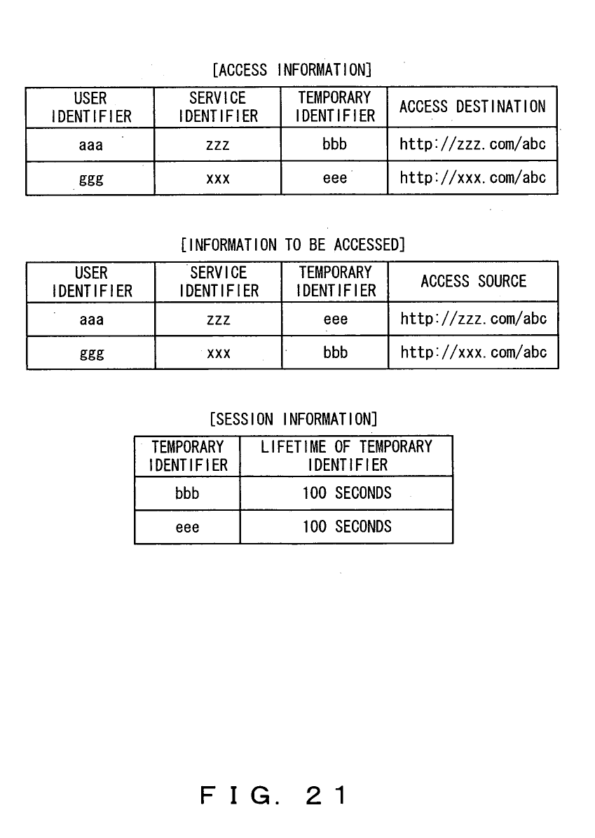

FIG. 21 explains information held by the user proxy device. In this figure, as access information for accessing the temporary identifier update request transmitting side device and the receiving side device, a user identifier of a user for each of the devices, an identifier of a service in each of the devices, a temporary user identifier corresponding to the user identifier, and an address of an access destination are stored. The first line of the access information is access information for the update request receiving side device, and the second line is access information for the update request transmitting side device if this figure is corresponded to FIGS. 19 and 20.

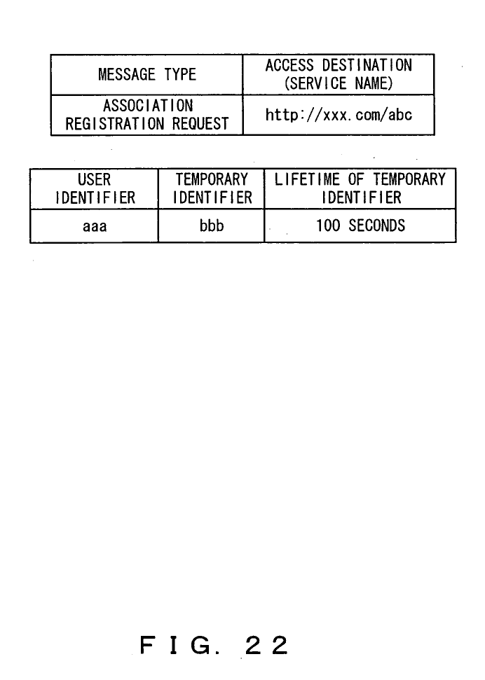

The user proxy device further holds information for respectively identifying accesses from the update request receiving side and transmitting side devices as the information to be accessed, and session information indicating the lifetimes of two temporary identifiers. FIGS. 22 to 25 to be described later explain information in a case where a random number value is used as a temporary identifier.

FIG. 22 explains information included in the association registration request message, for example, information included in the association registration request message shown in FIG. 9. Firstly, information indicating that a message type is an association registration request, and an address of an access destination of the message are stored. Additionally, a temporary identifier corresponding to a user identifier, and the lifetime of the temporary identifier are stored.

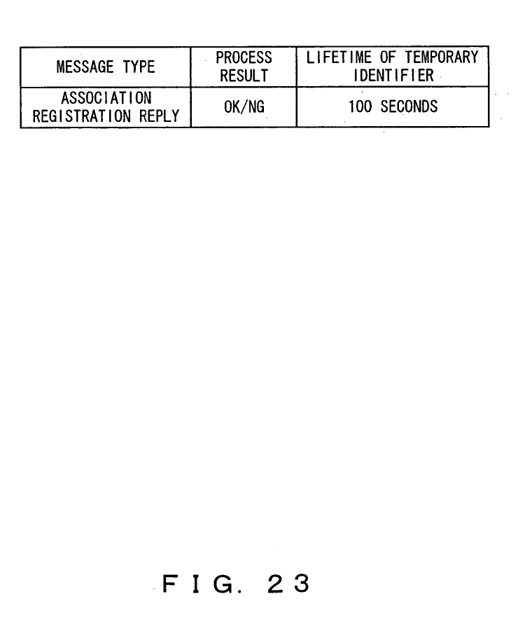

FIG. 23 explains information included in the association registration reply message. As this information, an association registration reply as a message type, whether a result of a process corresponding to the association registration request, namely, a result of a process for storing a pair of a user identifier and a temporary identifier, and a lifetime is either OK or NG, and the lifetime of the temporary identifier are stored. Here, the reason why the lifetime of the temporary identifier is stored is to enable the lifetime to be stored in the registration reply message and returned to the user proxy device, for example, if the temporary identifier update request transmitting side device, etc. desires to set a shorter lifetime according to circumstances of a service in response to the association registration request transmitted from the user proxy device.

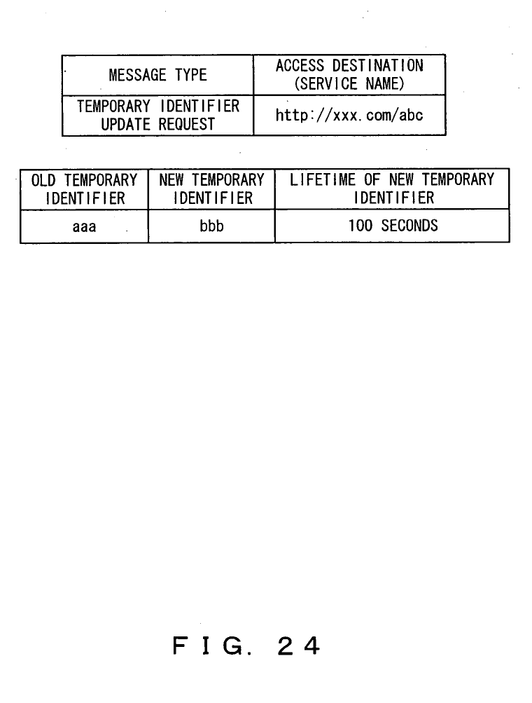

FIG. 24 explains information included in the temporary identifier update request message, for example, a message transmitted from the update request transmitting side device to the update request receiving side device in FIG. 13. In this figure, the message stores a temporary identifier update request as a message type, an address of an access destination of the message, old and new temporary identifiers, and the lifetime of the new temporary identifier. The address of the access destination, the name of the temporary identifier, etc. are not strictly uniformed, for example, with FIG. 19, etc.

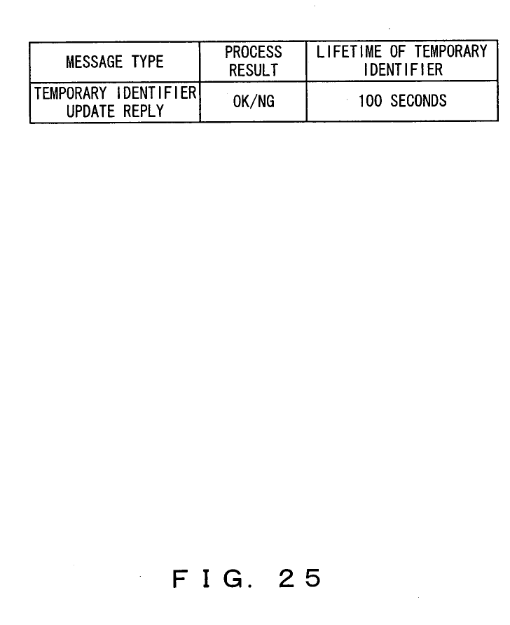

FIG. 25 explains information included in the temporary identifier update reply message. This message stores a temporary identifier update reply as a message type, a process result similar to that shown in FIG. 23, and the lifetime of a temporary identifier.

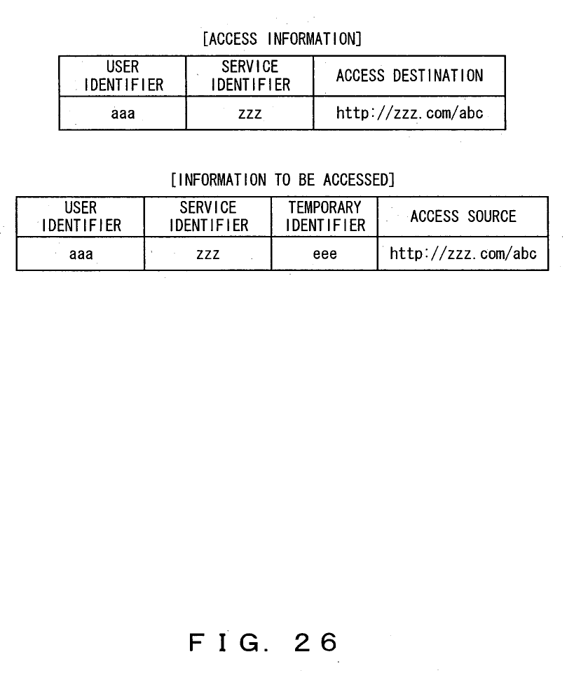

Information held by the respective devices when a temporary identifier is generated by using an irreversible operation such as a hash operation, etc. as described with reference to FIG. 4, and information included in the messages are described next with reference to FIGS. 26 to 30.

FIG. 26 explains information held by the temporary identifier update request transmitting side device. In this figure, access information and information to be accessed are held. Comparing with FIG. 19, a temporary identifier is not included in the information to be accessed. Here, a hash operation is assumed to be performed, by way of example, for a result of concatenating a user identifier, a service identifier, and a random number, slightly unlike the explanation of FIG. 4. However, there is no need to possess a temporary identifier as access information by holding a random number if an access is made by obtaining a temporary identifier with its calculation (hash operation?), and by using the temporary identifier each time the access must be made to the update request receiving side device. If the temporary identifier is continuously stored as access information, the temporary identifier cannot be always prevented from externally leaking. It is also one method to make a calculation for each access without storing a temporary identifier in the access information. Since the temporary identifier is not updated here, it is natural that the lifetime of the temporary identifier is not held unlike FIG. 19.

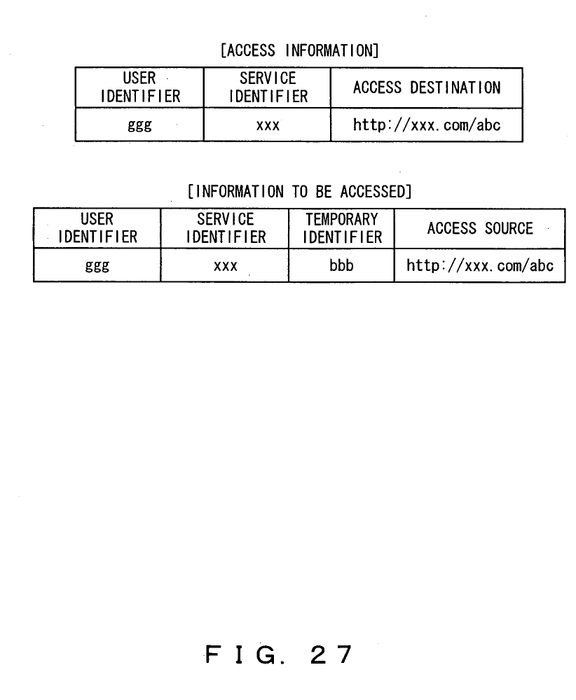

FIG. 27 explains information held by the temporary identifier update request receiving side device. Similar to the update request transmitting side device shown in FIG. 26, access information and information to be accessed are held, although in FIGS. 26 and 27, contents of a user identifier, an address, etc., are not corresponded between the respective devices, unlike FIGS. 19 and 20.

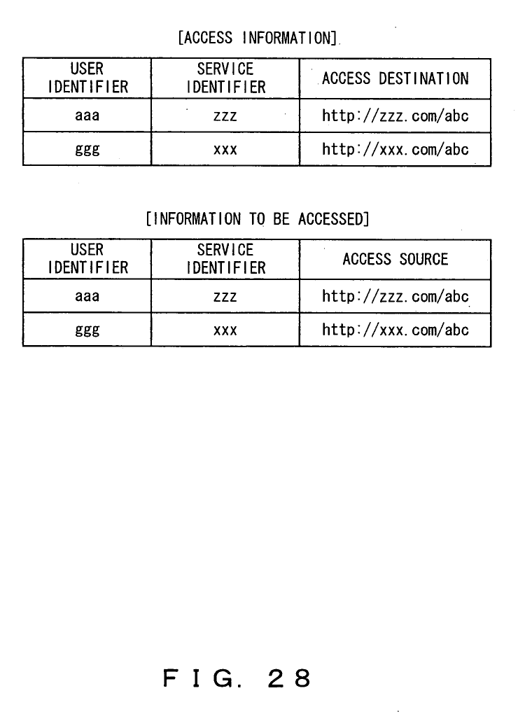

FIG. 28 explains information held by the user proxy device. Comparing with FIG. 21, the value of a temporary identifier is not held in access information and information to be accessed, and it is natural that the lifetime of the temporary identifier is not held. The reason is as follows: since the temporary identifier is not updated after an association registration is made, the value of the temporary identifier is evident in both of the update request transmitting side device and the receiving side device if a user identifier and a service identifier are specified, and can be calculated on demand.

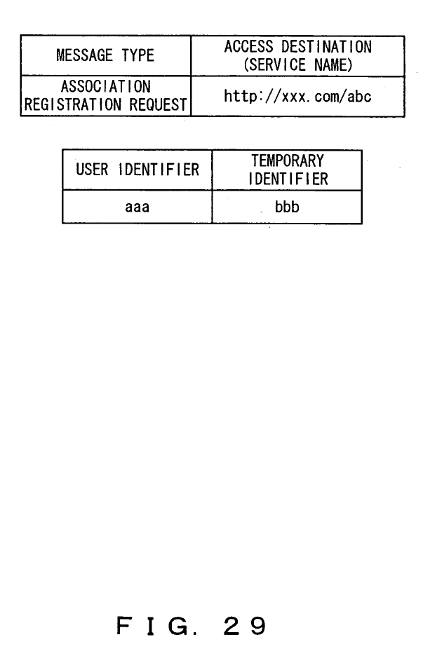

FIG. 29 explains information included in the association registration request message. Comparing with FIG. 22, the same information items are stored except for the lifetime of a temporary identifier because the temporary identifier is not updated.

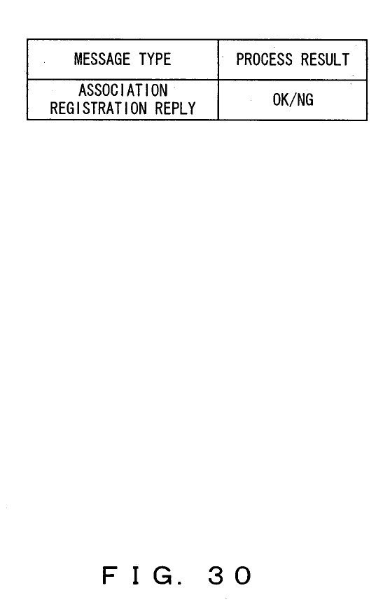

FIG. 30 explains information included in the association registration reply message. Since a temporary identifier is not updated, there is only a difference in a point that the lifetime of the temporary identifier is not updated in comparison with FIG. 23. In FIGS. 26 to 30, because the temporary identifier is not updated, the temporary identifier update request and update reply messages corresponding to FIGS. 24 and 25 are not used.

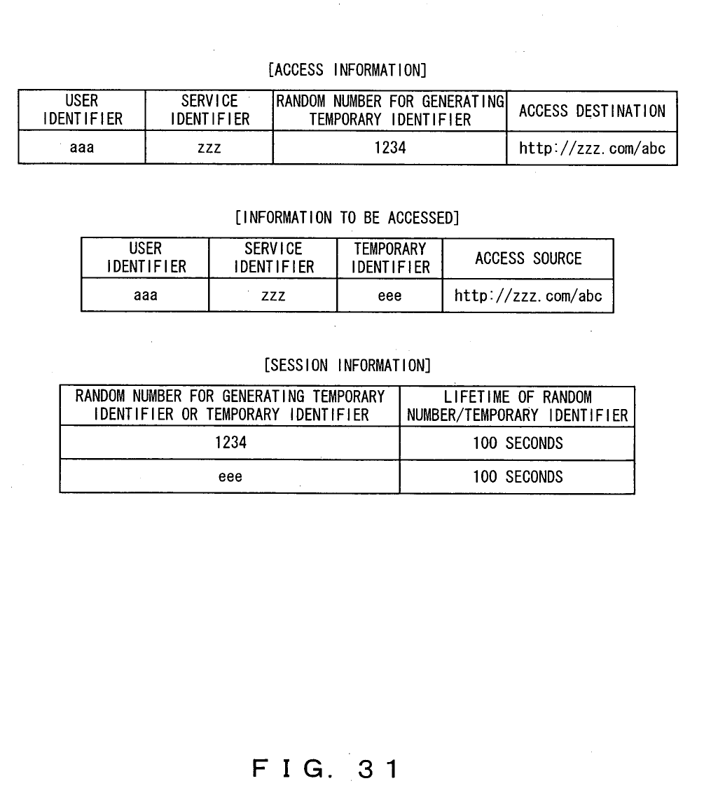

Information held by the respective devices when a temporary identifier is generated by using an irreversible operation such as a hash operation, etc., and the temporary identifier is updated in correspondence with its lifetime is explained next with reference to FIGS. 31 to 33. FIG. 31 explains information held by the temporary identifier update request transmitting side device. As access information, a random number for generating a temporary identifier is held in addition to a user identifier, a service identifier, and an address of an access destination. As explained with reference to FIG. 5, for example, on the service 1 side, a hash operation is performed by using the user identifier of the local device side, and a random number transmitted from a user, and a result of the hash operation is transmitted to the service 2 side. The random number for the hash operation is held as access information.

Information to be accessed is similar, for example, to that shown in FIG. 26, and stores a temporary identifier for identifying an access from the update request receiving side device. As session information, lifetimes are respectively held for the random number and the temporary identifier.

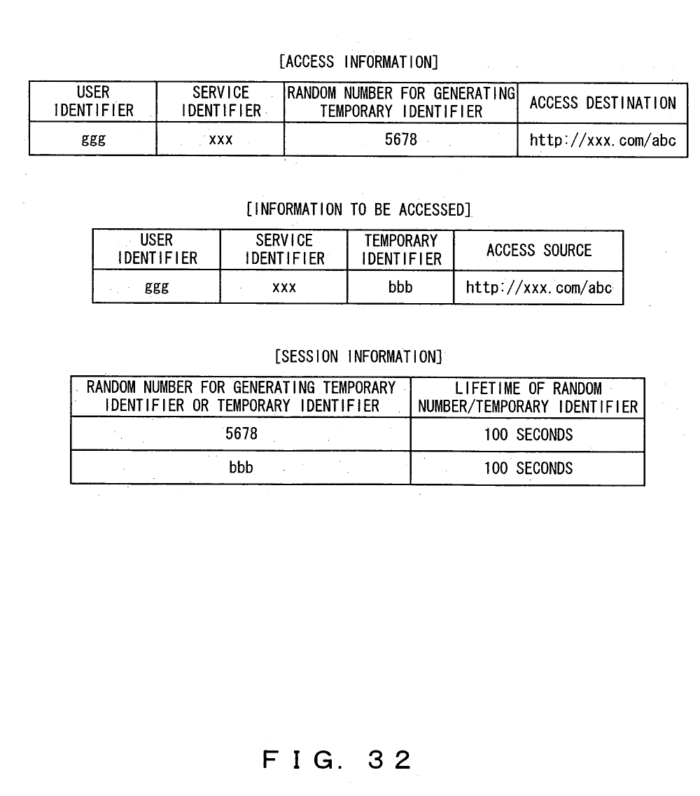

FIG. 32 explains information held by the temporary identifier update request receiving side device. Its contents are information having exactly the same format as that shown in FIG. 31, namely, the information held by the update request transmitting side device.

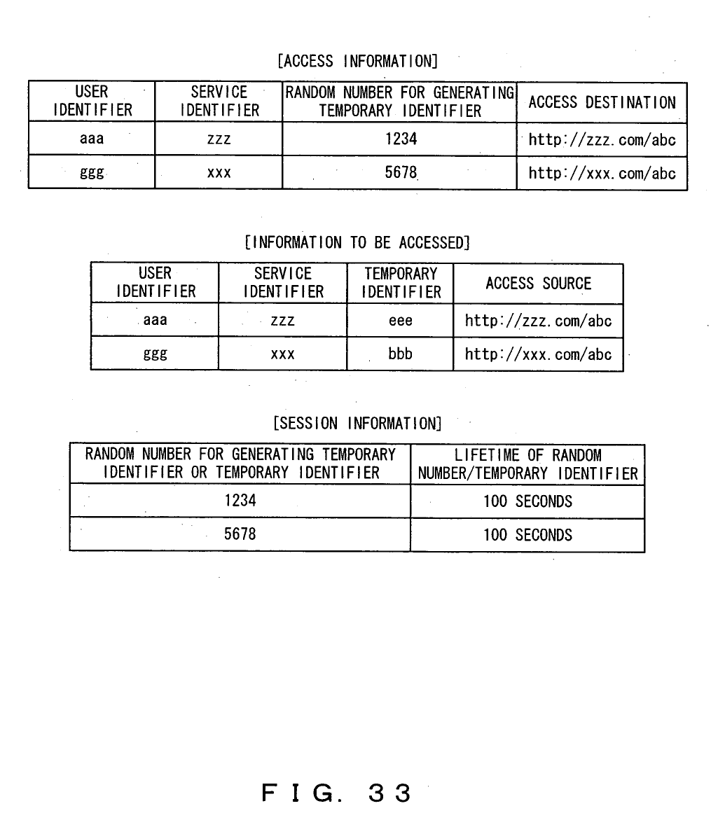

FIG. 33 explains information held by the user proxy device. Comparing, for example, with FIG. 21, there is a difference in a point that random numbers for generating temporary identifiers, namely, the values of random numbers respectively used in correspondence with the update request transmitting side device and the receiving side device are held instead of temporary identifiers, and the random numbers and the values of the lifetimes of the random numbers are held as session information. A case where the values of random numbers used in FIG. 5 are different between the sides of the services 1 and 2, namely, between the update request transmitting side device and the receiving side device is shown here.

Information included in the respective messages such as the association registration request message, the registration reply message, the temporary identifier update request message, and the update reply message when a temporary identifier is updated by using an irreversible operation such as a hash operation, etc. for a temporary identifier have the same formats as those of the information explained with reference to FIGS. 22 to 25 in a case where a random number value is used for a temporary identifier. Therefore, its explanation is omitted.

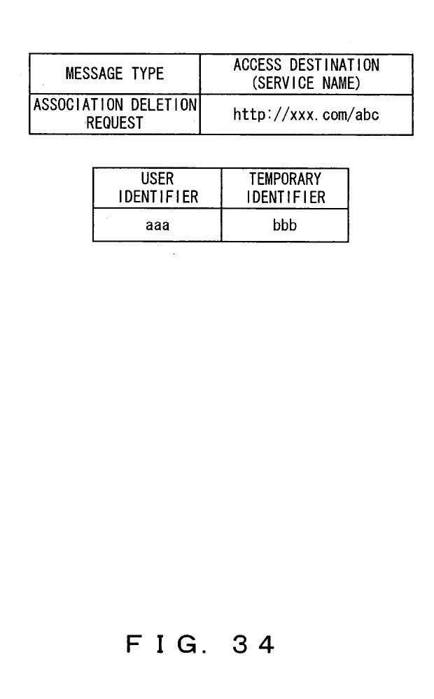

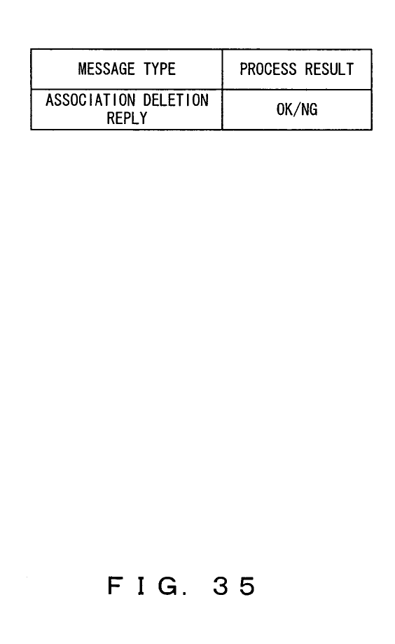

Lastly, information included in the association deletion request message and the association deletion reply message, which are used in the association deletion sequence shown in FIG. 18, is explained with reference to FIGS. 34 and 35.

FIG. 34 shows information included in the association deletion request message. An association deletion request as a message type, an address of an access destination, a temporary identifier to be deleted since an association becomes unnecessary, and a user identifier paring with the temporary identifier are stored. The association deletion reply message shown in FIG. 35 stores an association deletion reply as a message type, and information indicating OK or NG as a process result.

1. A network service system, where information of a user using a plurality of services is shared by the plurality of services, comprising:
a temporary user identifier update request transmitting side device, which provides a first service to the user, and which can transmit an update request of a temporary user identifier shared within the network service system as information of the user;
a temporary user identifier update request receiving side device, which is connected to said temporary user identifier update request transmitting side device by a network and can receive the update request of the temporary user identifier that is transmitted from said temporary user identifier update request transmitting side device, for providing a second service cooperating with the first service to the user by using the updated temporary user identifier in correspondence with the update request; and
a user proxy device, which is connected to said temporary user identifier update request transmitting side device and said temporary user identifier update request receiving side device by the network, and with which the user receives the first and the second services.

2. The network service system according to claim 1, wherein
said user proxy device comprises
a service information managing unit for holding user identifiers corresponding to services respectively provided by said temporary user identifier update request transmitting side device and said temporary user identifier update request receiving side device,
a temporary identifier generating unit for generating a temporary user identifier in correspondence with the user identifier, and
a communication processing unit for transmitting a message which includes a pair of the user identifier and the temporary user identifier to said two devices.

3. The network service system according to claim 1, wherein
said temporary user identifier update request transmitting side device comprises
a communication processing unit for receiving a message, which is transmitted from said user proxy device and includes a pair of a user identifier corresponding to the first service and a temporary user identifier,
a session managing unit for managing a valid time period of the temporary user identifier, and
a temporary user identifier generating unit for generating a new temporary user identifier before the valid time period of the temporary user identifier expires, wherein
said communication processing unit transmits a temporary identifier update request including the new temporary user identifier to said temporary user identifier update request receiving side device.

4. The network service system according to claim 1, wherein
said temporary user identifier update request receiving side device comprises
a communication processing unit for receiving a message which is transmitted from said user proxy device and includes a pair of the user identifier corresponding to the second service and the temporary user identifier, and the temporary identifier update request transmitted from said temporary user identifier update request transmitting side device, and
a session managing unit for setting a new temporary user identifier in correspondence with the temporary identifier update request received from said temporary user identifier update request transmitting side device after setting the temporary user identifier received from said user proxy device.

5. The network service system according to claim 1, wherein:
said user proxy device generates the temporary user identifier by using a random number in correspondence with the user identifiers of the user for the respective services provided by said temporary user identifier update request transmitting side device and said temporary user identifier update request receiving side device, and transmits an association registration request message which includes the generated temporary identifier and a valid time period of the temporary identifier to said temporary user identifier update request transmitting side device and said temporary user identifier update request receiving side device;
said temporary user identifier update request transmitting side device and said temporary user identifier update request receiving side device transmit an association reply message to said user proxy device side after setting the temporary identifier and the valid time period of the temporary identifier; and
said user proxy device sets the valid time period of the generated temporary identifier after receiving the association reply message transmitted from said two devices.

6. The network service system according to claim 5, wherein
said user proxy device generates the temporary user identifier by using a random number in correspondence with the user identifier.

7. The network service system according to claim 5, wherein
said user proxy device generates the temporary user identifier by using an irreversible operation in correspondence with the user identifier.

8. The network service system according to claim 1, wherein:
said temporary user identifier update request transmitting side device generates a new temporary user identifier before a valid time period of the temporary user identifier shared within the network service system expires, and transmits a temporary identifier update request message which includes the generated new temporary identifier and its valid time period to said temporary user identifier update request receiving side device; and
said temporary user identifier update request receiving side device transmits an update reply message to said temporary user identifier update request transmitting side device after setting the new temporary identifier and its valid time period.

9. The network service system according to claim 8, wherein
said temporary user identifier update request transmitting side device generates the temporary user identifier by using a random number in correspondence with the user identifier.

10. The network service system according to claim 8, wherein
said temporary user identifier update request transmitting side device generates the temporary user identifier by using an irreversible operation in correspondence with the user identifier.

11. A network service system, where information of a user using a plurality of services is shared by the plurality of services, comprising:
a user proxy device, with which the user receives the plurality of services cooperatively executed, for generating a temporary user identifier corresponding to a user identifier in the plurality of services, and for transmitting the temporary user identifier to devices respectively providing the plurality of services; and
a plurality of temporary user identifier update request receiving side devices, which are connected to said user proxy device by a network, for respectively providing the plurality of services cooperatively executed to the user by using the temporary user identifier transmitted from said user proxy device.

12. The network service system according to claim 11, wherein
said user proxy device comprises
a session managing unit for managing a valid time period of the temporary user identifier,
a temporary identifier generating unit for generating a new temporary identifier before the valid time period of the temporary user identifier expires, and
a communication processing unit for transmitting a temporary identifier update request to said plurality of temporary user identifier update request receiving side devices by using the new temporary identifier.

13. A device with which a user receives a plurality of services cooperatively executed via a network, comprising:
a service information managing unit for holding a user identifier in a service received by the user;
a temporary identifier generating unit for generating a temporary user identifier in correspondence with the user identifier; and
a communication processing unit for transmitting a message which includes a pair of the user identifier and the temporary user identifier to respective devices providing the plurality of services.

14. A device for providing to a user a different service executed cooperatively with a service provided to the user by other device within a network service system, comprising:
a communication processing unit for receiving a message which is transmitted from a user side and includes a pair of a user identifier corresponding to the different service, and a temporary user identifier that corresponds to the user identifier and is shared by the other device;
a session managing unit for managing a valid time period of the temporary user identifier; and
a temporary identifier generating unit for generating a new temporary user identifier before the valid time period of the temporary user identifier expires, wherein
said communication processing unit transmits a temporary user identifier update request including a new temporary user identifier to the other device side.

15. A device for providing to a user a different service executed cooperatively with a service provided to the user by other device within a network service system, comprising:
a communication processing unit for receiving a message which is transmitted from a user side and includes a pair of a user identifier corresponding to the different service, and a temporary user identifier that corresponds to the user identifier and is shared by the other device, and a temporary identifier update request transmitted from the other device; and
a session managing unit for setting a new temporary user identifier in correspondence with the temporary identifier update request after setting a temporary user identifier in correspondence with the message.
